(19) United States
(12) Patent Application Publication
(10) Pub. No.: US 2019/0284842 A1
(43) Pub. Date: Sep. 19, 2019

(54) DELIVERED PACKAGE THEFT DETERRENT SYSTEM

(71) Applicant: David Soares, Pipe Creek, TX (US)

(72) Inventor: David Soares, Pipe Creek, TX (US)

(21) Appl. No.: 15/681,375

(22) Filed: Aug. 19, 2017

(51) Int. Cl. E05B 73/00; G08B 13/14; G01S 19/42

(52) U.S. Cl. CPC E05B 73/0023; B65D 2211/00; G01S 19/42; G08B 13/1436

(57) ABSTRACT

A delivered package deterrent system includes a tracking and security device applied to and thus carried oy a package, and a mobile app residing in a package recipient mobile device to communicate with the tracking and security device to track the package and control deactivation of the tracking and security device upon delivery of the package into the custody of an authorized person.

### BACKGROUND OF THE INVENTION

### 1. Field of the Invention

The present general inventive concept relates generally to prevention of theft of delivered packages and, more particularly, to a delivered package theft deterrent system.

### 2. Description of the Related Art

The ordering of purchases online for delivery to a residence or business address is a commonality in today's society. However mailmen and deliverymen oftentimes leave packages at recipients' residences or business premises where the packages are vulnerable to observation and potentially theft, should an authorized person not be available to take custody of the delivered packages.

Therefore, there is a need for an approach to preventing theft of delivered packages left at recipients' residence or business premises.

### SUMMARY

The present general inventive concept provides a delivered package theft deterrent system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a delivered package theft deterrent system that may include a tracking and security device applied to and thus carried by a package, and a mobile app residing in a package recipient mobile device to communicate with the tracking and security device to track the package and control deactivation of the tracking and security device upon delivery of the package into the custody of an authorized person.

The tracking and security device of the delivered package theft deterrent system may include a Global Positioning System (GPS) tracking unit and a deterrent mechanism.

The deterrent mechanism of the tracking and security device may be an alarm siren.

The deterrent mechanism of the tracking and security device may be an ink bomb such that when activated it configured to spray liquid ink about the vicinity of the delivered package.

The ink bomb of the deterrent mechanism may be carried on a net carrier.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of the environment in which a delivered package theft deterrent system, according to an exemplary embodiment of the present general inventive concept, is employed;

FIG. 2 is a front perspective view of a tracking and security device of the system that is applied to a package to be delivered, according to the exemplary embodiment of the present general inventive concept; and

FIG. 3 is a front view of a theft deterrent mechanism of the system, according to the exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

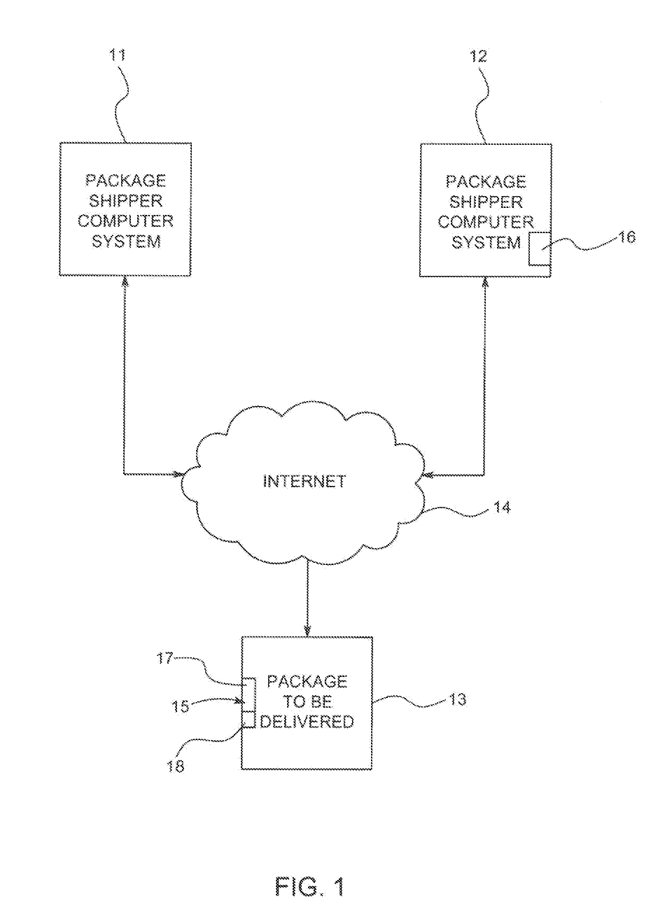

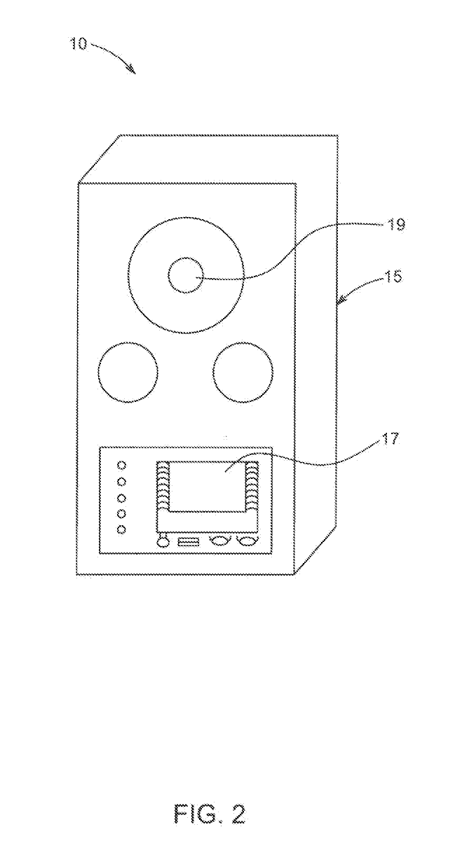

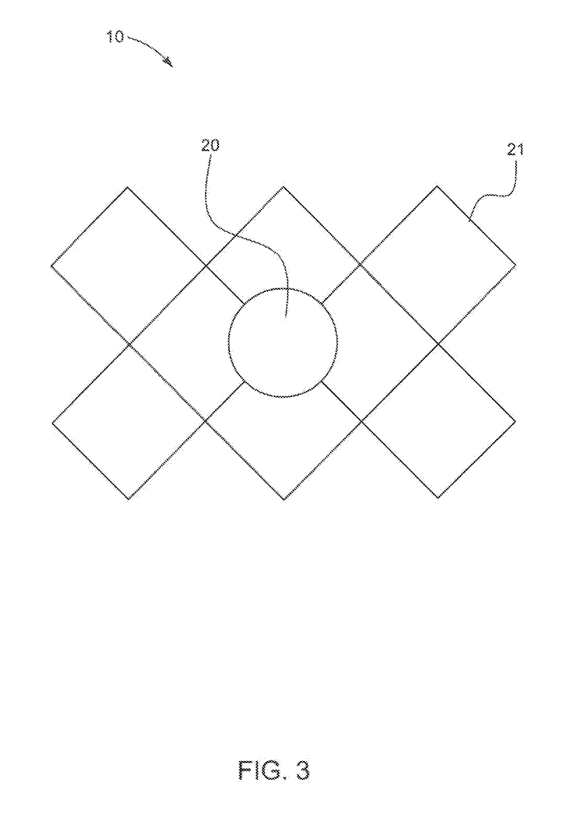

Referring now to FIGS. 1-3 of the drawings, there is illustrated a block diagram in FIG. 1 of the environment in which a delivered package deterrent system 10 of FIGS. 2 and 3 is employed, according to an exemplary embodiment of the present general inventive concept. The environment of FIG. 1 may encompass a package shipper having a package shipper computer system 11, a package recipient having a package recipient mobile device 12 and a package 13 to be delivered by the package shipper to the package recipient. The package shipper may have a website (not shown) that is hosted on its computer system 11. The package shipper computer system 11, the package recipient mobile device 12 and the package 13 may communicate wirelessly with one another via the Internet 14, as will be explained hereinafter.

The delivered package deterrent system 10 may include a tracking and security device 15, which is applied to and thus carried by the package 13, and a mobile app 16. The tracking and security device 15 may include a Global Positioning System (GPS) tracking unit 17 and a deterrent mechanism 18. The deterrent mechanism 18 may be one or both of an alarm siren 19 and an ink bomb 20. The ink bomb 20 may be carried on a mesh or net carrier 21 such that when it is activated it will spray liquid ink about the vicinity of the delivered package 13, the purpose for which will be made clear hereinafter.

The GPS tracking unit 17 uses the Global Positioning System to determine and track the unit's precise location, and hence to determine and track the precise location of the tracking and security device 15 of which the GPS tracking unit 17 is a component part and also to determine and track the precise location of the package 13 on which the tracking and security device 15 is applied, as they all travel together from the location of the package shipper to the location of the package recipient.

The mobile app 16 is customized to accommodate the requirements of the exemplary embodiment of the present general inventive concept as explained herein. Briefly as background, a mobile app is a special computer program designed to run on a mobile device, such as a smart-phone or tablet computer. The term “app” is a shortening of the term “software application”. The mobile app 16 may be obtained, via the Internet 14, from the website of the package shipper by downloading it onto the package recipient mobile device 12. The package recipient may select a password to use to access the mobile app 16 so that transactions with the package shipper may be carried out. For that matter all communications between the package shipper computer system 11, the package recipient mobile device 12 and the package 13, from the standpoint of the package recipient, will now take place via the mobile app 16 that resides in the package recipient mobile device 12.

The tracking and security device 14 of the system 10 may be applied to the package 13 just before the package 13 leaves the location of and is shipped by the package shipper to the location of the package recipient. The mobile app 16 enables the package recipient to be notified when the package 13 has been shipped and also delivered to the package recipient premises and further to allow the mobile app 16 to track the package 13 while on route as well as to permit the package recipient upon receipt of the package into authorized custody upon it being delivered to deactivate the deterrent or security mechanism 18 of the tracking and security device 14 through the package recipient's password-protected mobile app 16. Thus, the mobile app 16 enables the package delivery person to arm the deterrent mechanism of the system 10 once the package is delivered, and the package recipient can then use the mobile app 16 to disarm the deterrent mechanism. On the other hand, the system 10 will specifically function to protect packages from being compromised when recipients are not at the authorized drop-off location for retrieval.

The mobile app 16 enables the rightful, authorized recipient of the package to timely deactivate the deterrent or security mechanism 18, but if any unauthorized person disturbs the delivered package by moving it or picking it up, the delivered package deterrent system 10, via its tracking and security device 15, will sense the movement and activate and set off the alarm siren 19 and/or the ink bomb 20. Thus, the delivered package deterrent system 10 introduces an ingenious, practical solution to a recurring problem of delivered package theft that will powerfully discourage unauthorized persons from touching a delivered package 13 that employs the system 10. Built around the GPS tracking unit 17, this system 10 enables the shipped package 13 to be tracked and located at all times by both the package shipper and the package recipient. Communications with the GPS tracking unit 17, via the Internet 14, is enabled by means of the customized mobile app 16.

Movement of the package 13 by unauthorized persons while the mechanism is armed will trigger the operation of a loud, 130 dB alarm siren 19 as well as activating the operation of the ink bomb 20 attached to the package. The package 13 may include a very clear warning label to inform would-be thieves. The system 10 will provide package recipients with considerable peace of mind and package shippers with an appreciable reduction to their loss-mitigation costs. The system 10 may be utilized by a wide variety of users, such as Post Offices, shipping companies, and online retailers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A delivered package deterrent system, comprising:
a tracking and security device applied to and thus carried by a package;
a deterrent mechanism disposed on the tracking and security device to deter theft in response to an unauthorized person disturbing the package; and
a package recipient mobile device to communicate with the tracking and security device to track the package and control deactivation of the tracking and security device upon delivery of the package into the custody of an authorized person, such that the package recipient mobile device arms the deterrent mechanism.

2. The system of claim 1, wherein the tracking and security device includes a Global Positioning System (GPS) tracking unit.

3. The system of claim 1, wherein the deterrent mechanism of the tracking and security device is an alarm siren.

4. The system of claim 1, wherein the deterrent mechanism is an ink bomb such that when activated is configured to spray liquid ink about the vicinity of the delivered package.

5. The system of claim 4, wherein the ink bomb is carried on a net carrier.

6. A delivered package deterrent system, comprising:
a tracking and security device removably connected to a package, such that the tracking and security device is flush with an edge of the package, the tracking and security device comprising:
a GPS tracking unit to determine and track a location of the tracking and security device, and
a deterrent mechanism disposed on the tracking and security device to activate at least one of an alarm and an ink bomb in response to an unauthorized person disturbing the package; and
a package recipient mobile device to arm the deterrent mechanism after the package is delivered via an app.
